(19) United States
(12) Patent Application Publication
(10) Pub. No.: US 2010/0292987 A1
(43) Pub. Date: Nov. 18, 2010

(54) CIRCUIT STARTUP METHOD AND CIRCUIT STARTUP APPARATUS UTILIZING UTTERANCE ESTIMATION FOR USE IN SPEECH PROCESSING SYSTEM PROVIDED WITH SOUND COLLECTING DEVICE

(76) Inventors: Hiroshi Kawaguchi, Kobe-shi (JP); Masahiko Yoshimoto, Kobe-shi (JP); Hiroki Noguchi, Kobe-shi (JP); Tomoya Takagi, Kobe-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/774,923

(22) Filed: May 6, 2010

(30) Foreign Application Priority Data
May 17, 2009 (JP) 2009-119361

(51) Int. Cl. G10L 15/20

(52) U.S. Cl. 704/233; 704/E15.004

(57) ABSTRACT

A circuit startup method utilizing utterance estimation in a speech processing system including a sound collecting device is provided. The circuit startup method includes a subset power supply step of supplying power to the sound collecting device and a signal processing circuit, and a sound collecting step of inputting a sound from the sound collecting device through the signal processing circuit. The circuit startup method further includes an utterance estimation step of estimating whether or not a speech is contained in the inputted sound, and a power supply step of supplying power to the speech processing circuit for an utterance interval when it is estimated that a speech is contained from an estimation result of the utterance estimation step.

### BACKGROUND OF THE INVENTION

1. Field of the Invention

The present invention relates to a technology concerning a circuit startup method and circuit startup apparatus for performing power control of sound collecting devices (such as microphones, a microphone array), signal processing circuits (such as a preamplifier, an A/D converter, etc.) and speech processing circuits (such as a CPU, a memory, etc.) to reduce the power consumption of the sound collecting devices, the signal processing circuits, and the speech processing circuits.

2. Description of the Related Art

Conventionally, in application systems utilizing speeches (such as an audio teleconference system in which a plurality of microphones are connected together in a network, a robot system that performs speech recognition, a system including various speech interfaces), it is necessary to perform various speech processings such as sound source separation, denoising, echo cancellation, and so on to utilize clear speeches.

In these application systems utilizing speeches, the equipment has been consistently operating and performing wasteful processing during the operation of the microphones and the equipment even if numbers of intervals of no speech exist. Therefore, it is demanded to reduce the wasteful processing for such intervals of no speech, reduce wasteful power consumption entailing the same and reduce the power consumption of the entire application system.

A size reduction or an increase in the network scale in ubiquitous equipment, and heavy use of battery operating equipment such as sensor nodes and wearable equipment are anticipated in the future, and a technology for power consumption reduction is necessary.

As a technology for such power consumption reduction, a portable information processing apparatus including a telephone function, of which the power saving is achieved by performing power supply in accordance with the use style has been known (the Patent Document 1). The portable information processing apparatus suppresses the power consumption by interrupting power supply to the LCD panel while performing speech communications by using the built-in microphone and receiver.

Moreover, a system whose power consumption reduction is achieved by performing power supply control of individual memories and so on in accordance with instructions from a superordinate apparatus that controls the entire speech communication system has been known (See, for example, the Patent Document 2).

Prior art documents related to the present invention are as follows:

Patent Document 1: Japanese patent laid-open publication No. JP 2000-276268 A; and

Patent Document 2: Japanese patent laid-open publication No. JP 2008-288739 A.

As described above, there have been conventionally such an apparatus that suppresses the power consumption by interrupting the power supply to the LCD display device while speech communications are performed by the built-in microphone and receiver to reduce the power consumption of the portable telephone, and such an apparatus that achieves reduction in the power consumption by cutting off the powers of the individual memories and so on of the speech communication system.

However, there has been no idea to suppress the power consumption of the entire system of the audio teleconference system or the like by estimating the presence or absence of a human speech (utterance estimation). In general, the utterance estimation is a method to be used to improve the recognition rate of speech recognition after performing speech processings such as denoising and echo cancellation. Therefore, the utterance estimation is generally used after the speech processing and immediately before the speech recognition.

### SUMMARY OF THE INVENTION

In view of the above, it is an object of the present invention to provide a circuit startup method, a circuit startup apparatus and a circuit startup program product capable of achieving reduction in the power consumption of the entire speech processing system by utilizing utterance estimation.

It is a particular object to provide a circuit startup method and a circuit startup apparatus capable of achieving not only reduction in the power consumption of individual devices but also reduction in the power consumption of the entire system such as a networked microphone array system and an audio teleconference system.

In order to achieve the aforementioned objective, according to a circuit startup method of the first aspect of the present invention, there is provided a circuit startup method for use in a speech processing system including a sound collecting device, and the circuit startup method includes the following:

1-1) a subset power supply step of supplying power to the sound collecting device and a signal processing circuit;

1-2) a sound collecting step of inputting a sound from the sound collecting device through the signal processing circuit;

1-3) an utterance estimation step of estimating whether or not a speech is contained in the inputted sound; and

1-4) a power supply step of supplying power to the speech processing circuit for an utterance interval when it is estimated that a speech is contained from an estimation result of the utterance estimation step.

According to the above configuration, it is possible to achieve power consumption reduction of the entire speech processing system by performing utterance estimation processing before speech processing and controlling the circuit power of the speech processing and subsequent processings.

In this case, 1-1) the subset power supply step of supplying power to the sound collecting device and the signal processing circuit is, in concrete, processing to control a power supply line to a microphone device and a power supply line to an A/D converter for conversion of an analog signal outputted from the microphone device.

Moreover, 1-2) the sound collecting step of inputting a sound from the sound collecting device through the signal processing circuit is, in concrete, to temporarily take signal data taken in from the microphone device through the A/D converter into a memory.

Moreover, 1-3) the utterance estimation step of estimating whether or not a speech is contained in the inputted sound is to process the signal data taken in the sound collecting step in accordance with a predetermined utterance estimation algorithm. For the utterance estimation algorithm can be used various well-known algorithms such as utterance estimation using the sound pressure, utterance estimation using the number of zero crossings, utterance estimation using an autocorrelation, and utterance estimation using a speech feature. The utterance estimation algorithms are varied in the accuracy and the calculation amount and in the sampling frequency and the bit width of the signal data to be needed.

The utterance estimation algorithm using the sound pressure has such features that the accuracy is low and it is hard to use when the SN ratio is low although the calculation amount is small and simple processing. The utterance estimation algorithm using the number of zero crossings has such features that the calculation amount is small and simple though slightly larger than the utterance estimation using the sound pressure, and the accuracy is also comparatively high and operable even if the SN ratio is somewhat low. The utterance estimation algorithm using the autocorrelation has such features that the accuracy is high and it is not influenced by changes in the speech level although the calculation amount is large and it slightly lacks simplicity. The utterance estimation algorithm using the speech feature has such features that the calculation amount is large although the accuracy is the highest.

The utterance estimation required in a circuit startup method that can achieve reduction in the power consumption of the entire system demands accuracy not so much but rather attaches importance to simplicity. Therefore, it is preferable to use the utterance estimation algorithm using the number of zero crossings or the utterance estimation algorithm using the autocorrelation.

When an utterance estimation algorithm of simple operation is adopted, it is possible to reduce the sampling frequency and the bit width of the signal data to be needed. Therefore, it is possible to reduce the power consumption by controlling the sampling frequency and the bit width of the signal processing circuit (A/D converter) in addition to the power control during the utterance estimation.

Moreover, 1-4) the power supply step of supplying power to the speech processing circuit for the utterance interval when it is estimated that a speech is contained from the estimation result of the utterance estimation step is to supply power by controlling the line to supply power to the speech processing circuit for the utterance interval, i.e., for a time interval when a speech is contained when it is estimated that a speech is contained by the utterance estimation algorithm.

Moreover, the speech processing circuit implies a denoising circuit, an echo cancel circuit, a sound source separation circuit, a sound source direction specifying circuit, a speech recognition circuit, a sound recording circuit and the like.

Next, according to a circuit startup method of the second aspect of the present invention, there is provided a circuit startup method for use in a speech processing system including sound collecting devices, and the circuit startup method includes the following:

2-1) a subset power supply step of supplying power to a subset of the sound collecting devices and a signal processing circuit;

2-2) a sound collecting step of inputting a sound from the subset of the sound collecting devices through the signal processing circuit;

2-3) an utterance estimation step of estimating whether or not a speech is contained in the inputted sound; and

2-4) a power supply step of supplying power to the speech processing circuit, other sound collecting devices and other signal processing circuits for an utterance interval when it is estimated that a speech is contained from the estimation result of the utterance estimation step.

According to the above configuration, it is possible to achieve reduction in the power consumption of the entire speech processing system by supplying power only to the subset of the sound collecting devices and the signal processing circuit to reduce the number of sound collecting devices to be used when a plurality of sound collecting devices are provided in addition to performing the utterance estimation processing before the speech processing and controlling the circuit power of the speech processing and subsequent processings.

In a manner different from that of the circuit startup method of the first aspect, the circuit startup method of the second aspect supplies power not only to the speech processing circuit but also to other sound collecting devices and other signal processing circuits for the utterance interval when it is estimated that a speech is contained from the estimation result of the utterance estimation step in a manner similar to that of 2-4).

That is, reduction in the power consumption of the entire system is achieved by taking in a signal in the minimum configuration by the sound collecting devices (microphone array), performing the utterance estimation of the signal, supplying power to other channel signal paths only when the sound coincides with a human speech, and supplying power to the speech processing units of the subsequent stages of the denoising circuit and so on.

Next, according to a circuit startup method of the third aspect of the present invention, there is provided a circuit startup method for use in a speech processing system in which speech processing units including sound collecting devices are connected together in a network, and the circuit startup method includes the following:

3-1) a subset power supply step of supplying power to a subset of the sound collecting devices and a signal processing circuit of a self node;

3-2) a sound collecting step of inputting a sound from the subset of the sound collecting devices through the signal processing circuit;

3-3) an utterance estimation step of estimating whether or not a speech is contained in the inputted sound;

3-4) a power supply step of supplying power to the speech processing circuit, other sound collecting devices and other signal processing circuits of the self node for an utterance interval when it is estimated that a speech is contained from the estimation result of the utterance estimation step;

3-5) a startup signal transmission step of transmitting a circuit startup signal to other nodes when it is estimated that a speech is contained from the estimation result of the utterance estimation step; and

3-6) a self node power supply step of supplying power to the speech processing circuit, the sound collecting devices and the signal processing circuits of the self node when the circuit startup signal is received from other node.

According to the above configuration, it is possible to achieve reduction in the power consumption of the entire speech processing system by supplying power only to the subset of the sound collecting devices and the signal processing circuit by each node to reduce the number of sound collecting devices to be used by each node in the system in which the nodes including a plurality of sound collecting devices are connected together in a network in addition to performing the utterance estimation processing before the speech processing and controlling the circuit power of the speech processing and subsequent processings.

In a manner different from that of the circuit startup method of the second aspect, the circuit startup method of the third aspect transmits the circuit startup signal to other nodes when it is estimated that a speech is contained from the estimation result of the utterance estimation step in a manner similar to that of 3-5). Moreover, in a manner different from that of the circuit startup method of the second aspect, the circuit startup method of the third aspect performs the self node power supply for supplying power to the speech processing circuit, the sound collecting devices and the signal processing circuit of the self node when the circuit startup signal is received from other node in a manner similar to that of 3-6).

That is, reduction in the power consumption of the entire system is achieved by taking in a signal in the minimum configuration by the sound collecting devices (microphone array), performing the utterance estimation of the signal, supplying power to other channel signal paths only when the sound coincides with a human speech, supplying power to the speech processing units of the subsequent stages of the denoising circuit and so on, and outputting a command signal to supply power to the sound collecting devices and the speech processing circuits of other network nodes.

When it is estimated that a speech is contained from the estimation result of the utterance estimation step by the circuit startup methods of the first to third aspects, the bit length and/or the sampling frequency of the signal data should preferably be increased in the signal processing circuit.

By so doing, it is possible to reduce the power consumption by controlling the sampling frequency and the bit width of the signal processing circuit (A/D converter) in addition to the power control during the utterance estimation.

Moreover, by the circuit startup methods of the first to third aspects, the utterance estimation step should preferably use the number of zero crossings.

The utterance estimation algorithm using the number of zero crossings has such features that the calculation amount is small and simple though slightly larger than the utterance estimation using the sound pressure, and the accuracy is also comparatively high and operable even if the SN ratio is somewhat low. It is noted that malfunctioning increases in an environment of a low SN ratio in the case of the utterance estimation that has a small calculation amount and simply utilizes the sound pressure.

Next, according to a circuit startup program product of the aspect of the present invention, there is provided a circuit startup program product for use in a speech processing system in which speech processing units including sound collecting devices are connected together in a network, in which the steps constituting any method of the circuit startup methods of the first to third aspects are executed by a computer.

Next, according to a circuit startup apparatus of the first aspect of the present invention, there is provided a circuit startup apparatus for use in a speech processing system including a sound collecting device, and the circuit startup apparatus includes the following:

A-1) a subset power supply circuit for supplying power to the sound collecting device and a signal processing circuit;

A-2) a sound collecting device for inputting a sound from the sound collecting device through the signal processing circuit;

A-3) an utterance estimation circuit for estimating whether or not a speech is contained in the inputted sound; and

A-4) a power supply circuit for supplying power to the speech processing circuit for an utterance interval when it is estimated that a speech is contained from the estimation result of the utterance estimation circuit.

According to the above configuration, it is possible to achieve reduction in the power consumption of the entire speech processing system by performing the utterance estimation processing before the speech processing and controlling the circuit power of the speech processing and subsequent processings.

In this case, A-1) the subset power supply circuit for supplying power to the sound collecting device and the signal processing circuit is, in concrete, a control circuit that controls the power supply line to the microphone device and a power supply line to the A/D converter that converts an analog signal outputted from the microphone device.

Moreover, A-2) the sound collecting device for inputting a sound from the sound collecting device through the signal processing circuit is, in concrete, a memory that temporarily stores signal data taken in from the microphone device through the A/D converter.

Moreover, A-3) the utterance estimation circuit for estimating whether or not a speech is contained in the inputted sound is a processing circuit of the signal data taken in by the sound collecting device in accordance with a predetermined utterance estimation algorithm.

Moreover, A-4) the power supply circuit for supplying power to the speech processing circuit for the utterance interval when it is estimated that a speech is contained from the estimation result of the utterance estimation circuit is to supply power by controlling the power supply line to the speech processing circuit for the utterance interval, i.e., for a definite time interval when a speech is contained when it is estimated that a speech is contained according to the utterance estimation algorithm.

It is noted that the utterance estimation algorithm, the utterance interval and the speech processing circuit are similar to those described above, and no description is provided for them.

Moreover, according to a circuit startup apparatus of the second aspect of the present invention, there is provided a circuit startup apparatus for use in a speech processing system including sound collecting devices, and the circuit startup apparatus includes the following:

B-1) a subset power supply circuit for supplying power to a subset of the sound collecting devices and the signal processing circuit;

B-2) a sound collecting circuit for inputting a sound from the subset of the sound collecting devices through the signal processing circuit;

B-3) an utterance estimation circuit for estimating whether or not a speech is contained in the inputted sound; and

B-4) a power supply circuit for supplying power to the speech processing circuit, other sound collecting devices and other signal processing circuits for an utterance interval when it is estimated that a speech is contained from the estimation result of the utterance estimation circuit.

According to the above configuration, it is possible to achieve reduction in the power consumption of the entire speech processing system by supplying power only to the subset of the sound collecting devices and the signal processing circuit to reduce the number of sound collecting devices to be used when a plurality of sound collecting devices are provided in addition to performing the utterance estimation processing before the speech processing and controlling the circuit power of the speech processing and subsequent processings.

Moreover, according to a circuit startup apparatus of the third aspect of the present invention, there is provided a circuit startup apparatus for use in a speech processing system in which speech processing units including sound collecting devices are connected together in a network, and the circuit startup apparatus includes the following:

C-1) a subset power supply circuit for supplying power to a subset of the sound collecting devices and the signal processing circuit of the self node;

C-2) a sound collecting device for inputting a sound from the subset of the sound collecting devices through the signal processing circuit;

C-3) an utterance estimation circuit for estimating whether or not a speech is contained in the inputted sound;

C-4) a power supply circuit for supplying power to the speech processing circuit of the self node, other sound collecting devices and other signal processing circuits for an utterance interval when it is estimated that a speech is contained from the estimation result of the utterance estimation circuit;

C-5) a startup signal transmission circuit for transmitting a circuit startup signal to other nodes when it is estimated that a speech is contained from the estimation result of the utterance estimation circuit; and

C-6) a self node power supply circuit for supplying power to the speech processing circuit, the sound collecting devices and the signal processing circuits of the self node when the circuit startup signal is received from other node.

According to the above configuration, it is possible to achieve reduction in the power consumption of the entire speech processing system by supplying power only to the subset of the sound collecting devices and the signal processing circuit by each node to reduce the number of sound collecting devices to be used by each node in the system in which the nodes including a plurality of sound collecting devices are connected together in a network in addition to performing the utterance estimation processing before the speech processing and controlling the circuit power of the speech processing and subsequent processings.

According to the present invention, by taking in the signal in the minimum sound collecting device configuration, performing utterance estimation of the signal, supplying power to other channel signal paths only when the sound coincides with a human speech, supplying power to the speech processing unit of denoising and so on, and further outputting a power supply command signal to the sound collecting devices and the signal processing circuits of other network nodes, there are produced such advantageous effects that reduction in the power consumption of the entire speech processing system can be achieved by using the utterance estimation in a microphone array system, an audio teleconference system, home information appliances using speeches, and so on.

### BRIEF DESCRIPTION OF THE DRAWINGS

These and other objects and features of the present invention will become clear from the following description taken in conjunction with the preferred embodiments thereof with reference to the accompanying drawings throughout which like parts are designated by like reference numerals, and in which:

FIG. 1 is a block diagram of a speech processing system in which a circuit startup apparatus of the present invention is incorporated;

FIG. 2 is a flow chart of a first circuit startup method of the present invention;

FIG. 3 is a flow chart of a second circuit startup method of the present invention;

FIG. 4 is a flow chart of a third circuit startup method of the present invention;

FIG. 5 is a block diagram of a system configuration and a sensor node of a first implemental example;

FIG. 6 is an explanatory view of an utterance estimation algorithm of the first implemental example;

FIG. 7 is a flow chart of the utterance estimation algorithm of the first implemental example;

FIG. 8 is a hardware block diagram of the utterance estimation circuit module of the first implemental example;

FIG. 9 is a chart of a circuit state in a sensor node for a noise interval (non-utterance interval or non-speech interval);

FIG. 10 is a chart of a circuit state in the sensor node for an utterance interval;

FIG. 11 is a process flow (1) of the sensor node of the first implemental example;

FIG. 12 is a process flow (2) of the sensor node of the first implemental example;

FIG. 13A is a graph showing a tolerance of the utterance estimation circuit module of the first implemental example to S/N deterioration, and showing a frequency of correct in the output of the utterance estimation circuit module;

FIG. 13B is a graph showing a tolerance of the utterance estimation circuit module of the first implemental example to S/N deterioration, and showing a frequency of surplus in the output of the utterance estimation circuit module;

FIG. 13C is a graph showing a tolerance of the utterance estimation circuit module of the first implemental example to S/N deterioration, and showing a frequency of deficit in the output of the utterance estimation circuit module;

FIG. 14A is a graph showing a power consumption of the entire sensor node at an utterance time in the system of the first implemental example; and

FIG. 14B is a graph showing a power consumption of the entire sensor node at a non-utterance time in the system of the first implemental example.

### DETAILED DESCRIPTION OF THE PREFERRED EMBODIMENTS

Preferred embodiments of the present invention will be described in detail below with reference to the drawings. The scope of the present invention is not limited to the following implemental examples and the illustrative examples but allowed to be variously altered and modified.

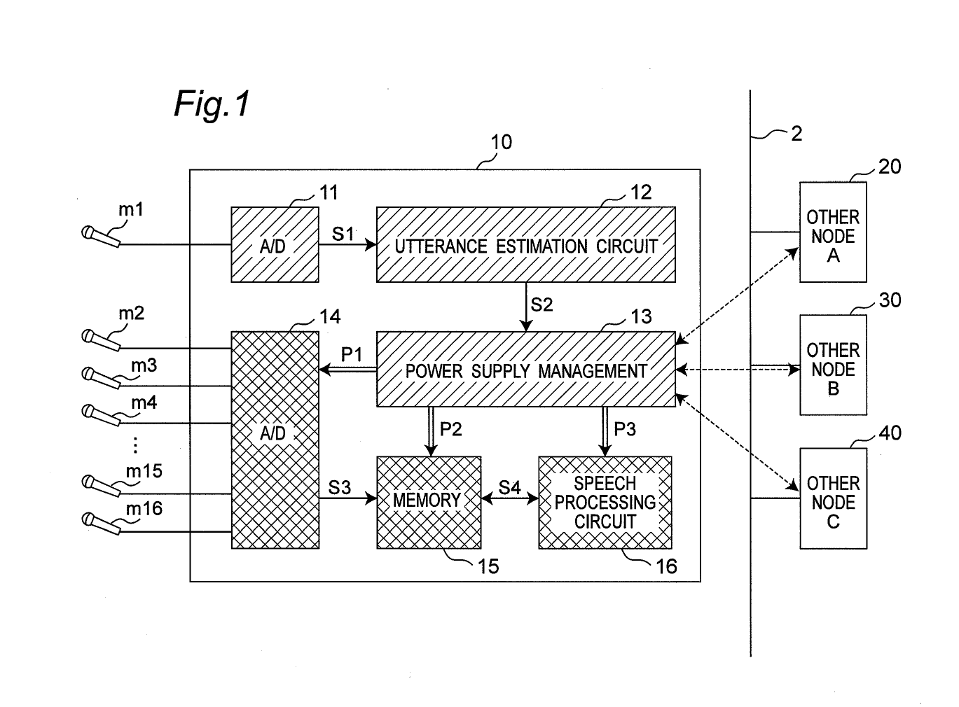

One preferred embodiment of the circuit startup apparatus of the present invention will be described. FIG. 1 shows a block diagram of a speech processing system in which the circuit startup apparatus of the present invention is incorporated.

In concrete, the circuit startup apparatus of the present invention is constituted of an utterance estimation circuit 12 and a power supply circuit 13 as shown in FIG. 1. Referring to FIG. 1, a plurality of speech processing units 10 provided with microphones (sound collecting devices) is connected in a network 2. In a state in which electric power (referred to as a power hereinafter) is supplied to one microphone (sound collecting device) m1 and an A/D converter (signal processing circuit) 11, a sound is inputted from the one microphone m1 to the utterance estimation circuit 12 through the A/D converter 11. The utterance estimation circuit 12 estimates whether or not a speech is contained in the inputted sound. When it is estimated that a speech is contained from the estimation result of the utterance estimation circuit, then the utterance estimation circuit 12 outputs a signal S2 to the power supply management circuit 13 for the utterance interval. The power supply management circuit 13 supplies the power to a speech processing circuit 16, a memory 15, the other microphones (m2 to m16) and the other A/D converters 14. Then, the power supply management circuit 13 transmits a circuit startup signal to the other nodes (20 to 40).

Moreover, when the circuit startup signal is received from the other node, the power supply management circuit 13 supplies the power to the speech processing circuit 16, the memory 15, the other microphones (m2 to m16), and the other A/D converters 14.

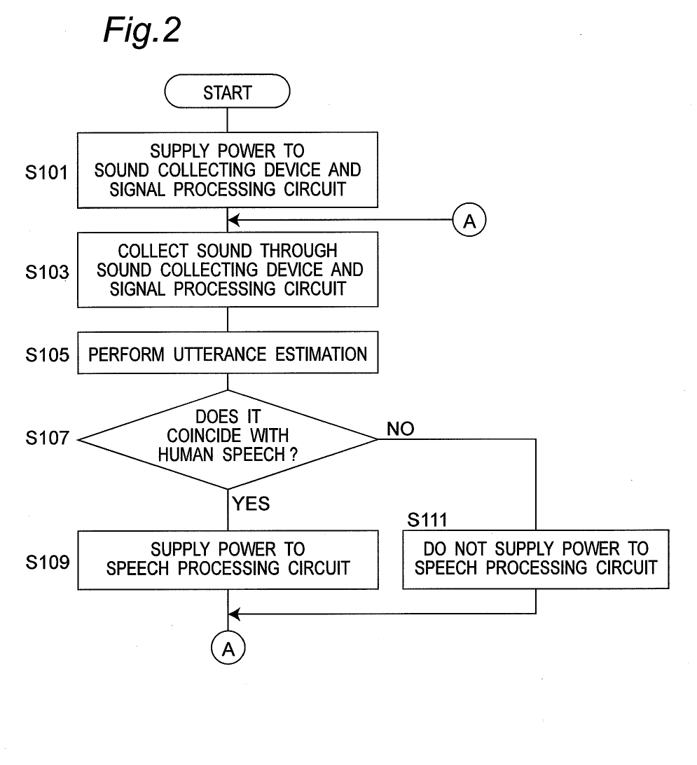

Next, one preferred embodiment of the circuit startup method of the present invention is described. FIGS. 2 to 6 show processing flows of the circuit startup method of the present invention.

First of all, the circuit startup method 1 of the present invention shown in FIG. 2 supplies the power to the microphone (sound collecting device) and the A/D converter (signal processing circuit) (S101). Next, a sound is collected through the sound collecting device and the signal processing circuit (S103). Next, the utterance estimation is performed for the collected sound (S105). Then, it is discriminated whether or not the sound coincides with a human speech as a result of estimation (S107), and the power is supplied to the speech processing circuit when it is estimated to be an utterance (S109). When it is estimated to be a non-utterance (including a noise case where no speech is recognized), no power is supplied to the speech processing circuit (S111), and the program flow returns to the process (S103) of collecting a sound through the sound collecting device and the signal processing circuit.

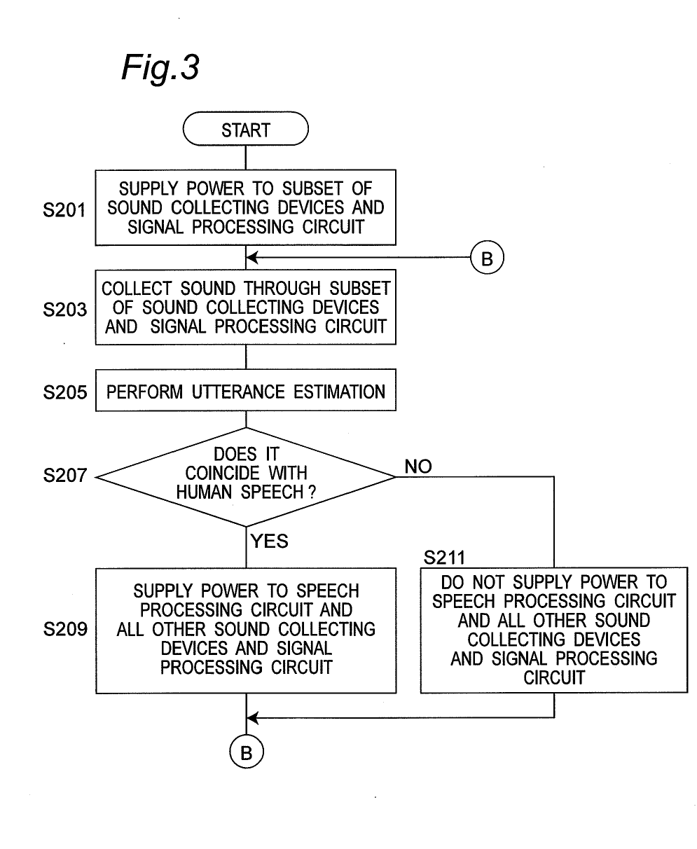

Next, the circuit startup method 2 of the present invention shown in FIG. 3, which is almost similar to the processing of the circuit startup method 1 described above, initially supplies the power only to a subset of microphones (sound collecting devices) and the A/D converter (signal processing circuit) (S201). When the sound coincides with a human speech by an utterance estimation process (S205), the power is supplied to the speech processing circuit and all of the other sound collecting devices and signal processing circuits (S209).

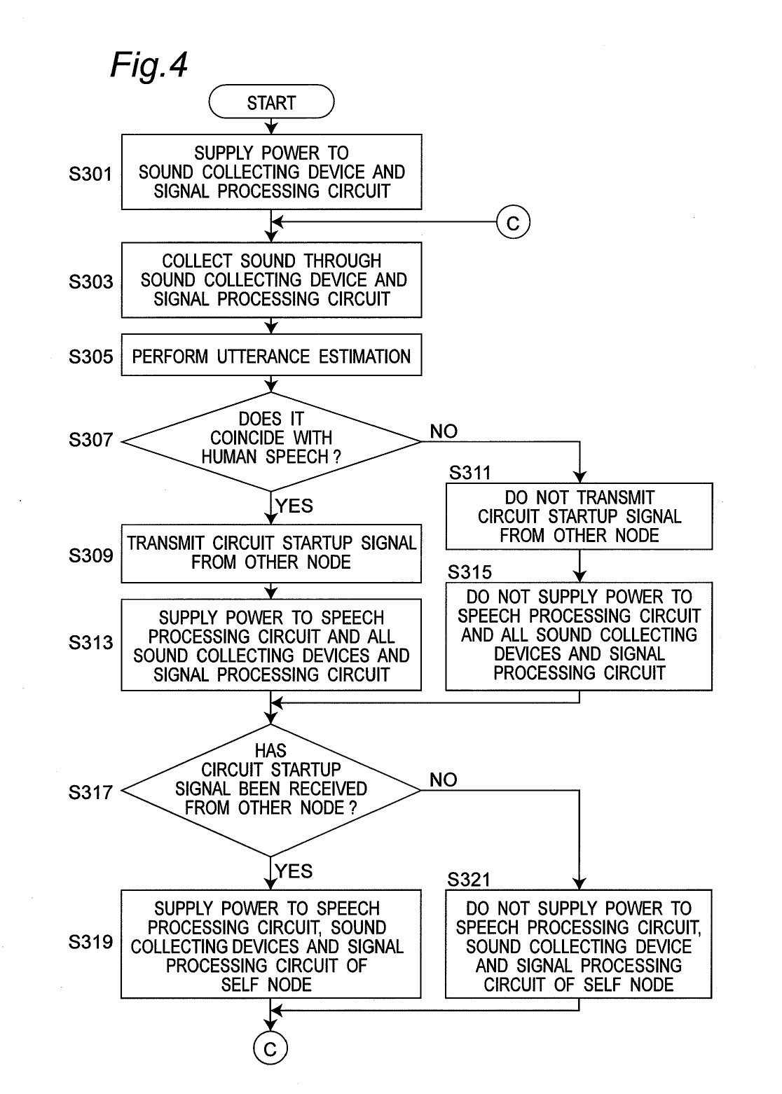

The circuit startup method of the present invention shown in FIG. 4 supposes processing of nodes connected in a network, and is almost similar to the processing of the circuit startup method 2 described above. When the sound coincides with a human speech by an utterance estimation process (S305), the method is performed by transmitting a circuit startup signal to the other nodes (S309) and supplying the power to the speech processing circuit, all of the other sound collecting devices and signal processing circuits (S313). Moreover, when the circuit startup signal is received from the other node (S317), the power is supplied to the speech processing circuit, the sound collecting devices and the signal processing circuit of the self node (S319).

### First Implemental Example

As an implemental example of the circuit startup apparatus of the present invention, a ubiquitous sensor system that performs speech signal processing is taken as an example and described including the extent to which the power consumption of the system can be reduced in concrete.

A speech interface is the most basic transmission means or circuit and has a wide variety of application ranges. For example, in a conference system using a microphone array of 128 channels, each sensor node performs signal collection and denoising, and each sensor node is in charge of various processes of person position estimation, speech recognition and talker identification.

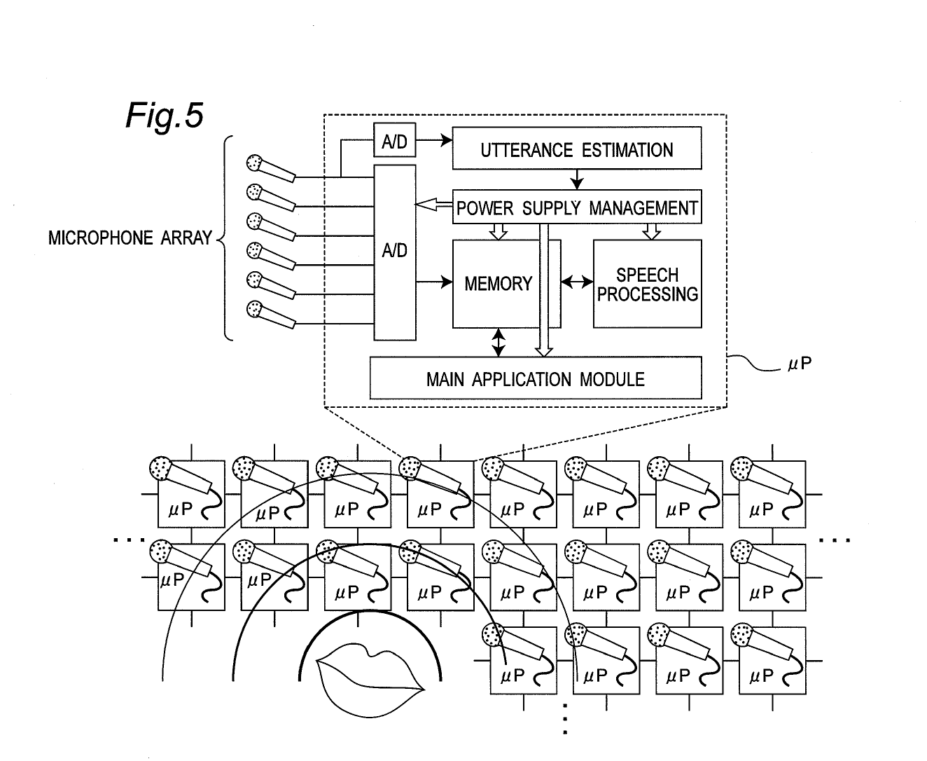

FIG. 5 shows a conceptual diagram of a ubiquitous sensor network and a block diagram of a single sensor node. Each sensor node has a configuration of the circuit startup apparatus of the present invention, and is configured to include a microprocessor (μP) and a microphone array.

The power consumption of each sensor node is described. Estimating the power consumed by each sensor node, it can be estimated that wireless data communication consumes a current of 14.0 mA, one microphone consumes a current of about 0.1 mA, and the microprocessor consumes a current of about 10 mA. When the power is kept turned on, each sensor node can operate for about seven hours on a button battery having a battery capacity of 150 mAh (a general button battery can supply energy of roughly 60 to 200 mAh). Therefore, it is necessary to reduce the power consumption to a current of about 6.25 mA in order that each sensor node operates for 24 hours.

In the sensor node having the configuration of the circuit startup apparatus of the present invention in a manner similar to that of FIG. 5, two hardware units of an utterance estimation circuit module and a power supply management circuit module are added in a manner different from that of the conventional sensor node. The utterance estimation circuit module outputs whether or not speech data is contained in the input signal to the power supply management circuit module.

Only when the utterance estimation circuit module detects a speech, the power supply management circuit module supplies the power to the main circuit modules (main application module, signal processor module, memory and A/D converter). Therefore, while no speech signal is detected, the power supply to the main circuit modules is interrupted by the power supply management circuit module. When a non-utterance time is longer, the power can be saved by that much, and this leads to an improvement in the operating time. Further, since the utterance estimation circuit module operates also in a non-utterance time, it is possible to further improve the operating time by reducing the power consumption of the utterance estimation circuit module itself.

Next, the utterance estimation circuit module is described. The utterance estimation algorithm implemented in the utterance estimation circuit module is provided for detecting the utterance interval from the sound inputted from the microphone taking advantage of the characteristic difference between a noise and a speech. The utterance estimation algorithm is practically utilized for a technology (VoIP: Voice over Internet Protocol) to transmit and receive speech data by using speech recognition or a network such as the Internet, an intranet or the like. Although a simple utterance estimation algorithm is regarded suitable in a real-time system such as Internet phone, the viewpoint of the power consumption has been scarcely considered in implementing the conventional utterance estimation algorithm. As a result, numbers of complicated ones based on the language model are proposed as the conventional utterance estimation algorithms.

From the viewpoint of the power consumption, an utterance estimation algorithm in a time domain is suitable for reducing the power consumption of the utterance estimation circuit module. By comparison to the utterance estimation algorithm in a frequency domain, the utterance estimation algorithm in the time domain has a small calculation amount although the accuracy is low. Moreover, the utterance estimation algorithm in the frequency domain has a large calculation amount although it produces high accuracy even under a degraded S/N ratio environment. An utterance estimation algorithm using the number of zero crossings has such a feature that estimation can be achieved even with a speech of low energy among the utterance estimation algorithms in the time domain.

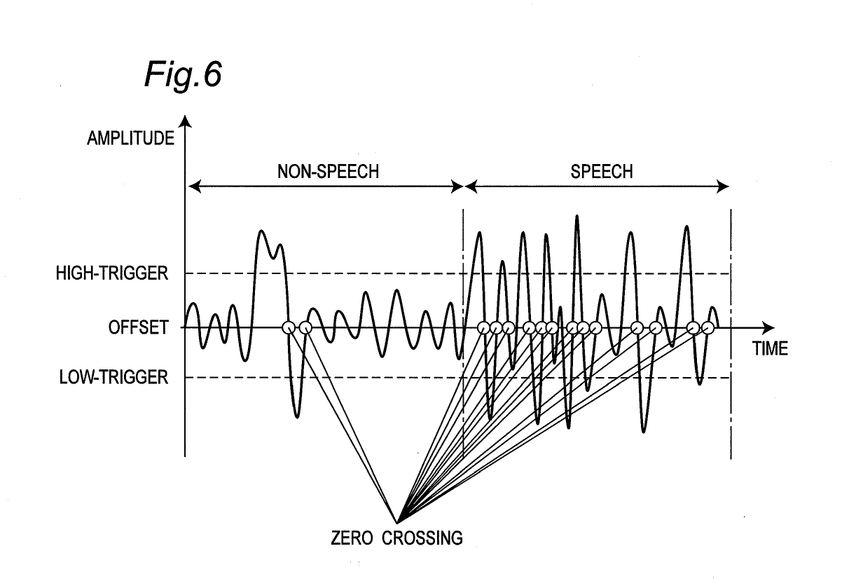

FIG. 6 shows a mechanism of the utterance estimation algorithm using the number of zero crossings. The utterance estimation algorithm using the number of zero crossings counts the number of crossings with an offset line immediately after the input signal exceeds a trigger level. The utterance estimation algorithm using the number of zero crossings detects the utterance interval by detecting a difference in the number of zero crossings between the utterance time and the non-utterance time.

In order that the utterance estimation algorithm using the number of zero crossings operates, it is only required to discriminate whether or not the input signal has exceeded the trigger level and whether or not it has crossed the offset, and therefore, no detailed speech data is necessary. Therefore, it is possible to reduce the sampling frequency and the bit count to the minimum.

As described above, the main signal processing operates when the utterance estimation circuit module detects an utterance, and therefore, the sampling frequency and the bit count are raised after the utterance is detected. In the present implemental example, the main speech signal processing performs sampling in 16 bits at a sampling frequency of 16 kHz in a manner similar to that of almost all the speech recognition systems. Then, for the utterance estimation algorithm, sampling is performed in 10 bits at a sampling frequency of 2 kHz as a parameter of ADC (Analog Digital Converter) sufficient for detecting the human utterance. It is noted that the parameter of ADC (Analog Digital Converter) should be determined depending on the processing contents of the speech signal processing in the main application module and so on implemented on the system.

When hardware implementing is considered, cooperation with an ADC (Analog Digital Converter) circuit is important. The offset shown in FIG. 6 is an average of the output of the ADC (Analog Digital Converter) circuit and changes in accordance with the temperature, voltage, noise and the other environments. Accordingly, the output of the ADC (Analog Digital Converter) circuit is generally normalized to 0 to 1 or −1 to 1. The normalization makes it possible to stabilize the operation of the system that keeps operating for a long term. However, in order to reduce the calculation amount of the utterance estimation circuit module, integer implementation is better than decimal implementation in all calculations. Therefore, a mechanism to adjust the offset is used for the algorithm of the number of zero crossings so that all calculations can be performed not in decimals but in integers.

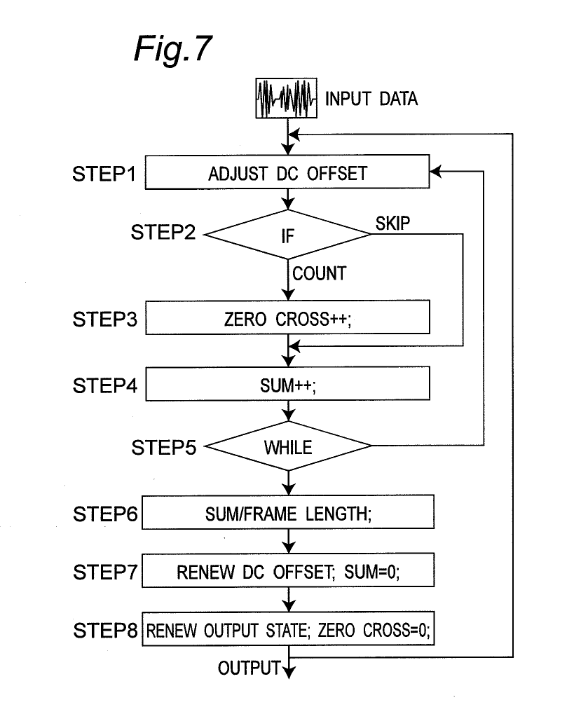

FIG. 7 shows a flow chart of an utterance estimation algorithm including the mechanism to adjust the offset. The concrete processing contents of the steps of FIG. 7 are shown as follows.
Process 1 (Step 1): Input data is adjusted so as not to overflow.
Process 2 (Step 2): It is judged whether or not input data has a zero crossing.
Process 3 (Step 3): When a zero crossing condition is satisfied, it is counted as a number of zero crossings.
Process 4 (Step 4): The input data are summed up to obtain an average value in the present frame.
Process 5 (Step 5): The length of the input data is counted to adjust the frame length.
Process 6 (Step 6): By dividing the total sum in the frame by the frame length, an average value in the present frame is obtained.
Process 7 (Step 7): The DC offset is adjusted by using the average value.
Process 8 (Step 8): The output state is renewed by using the number of zero crossings, and the program flow returns to the first step.

The average of the input amplitude is calculated in the above process 6, and this is to achieve calculations only by integer calculations. The frame length is preparatorily reformed to a value expressible by the multiplier of two so that the average value can be obtained only by an adder and shift operation. When the average of the output of the ADC (Analog Digital Converter) circuit is obtained, the utterance estimation circuit module obtains the number of zero crossings by the process 2 and the process 3. The total calculation amount from the process 1 to the process 8 is about 3 KOPS.

The utterance estimation algorithm was implemented on FPGA (Field Programmable Gate Array) to verify the power consumption in the hardware of the utterance estimation circuit module. The measured power denotes the power of the whole FPGA board, and it does not include the power of the microphones but includes the power of the ADC circuit.

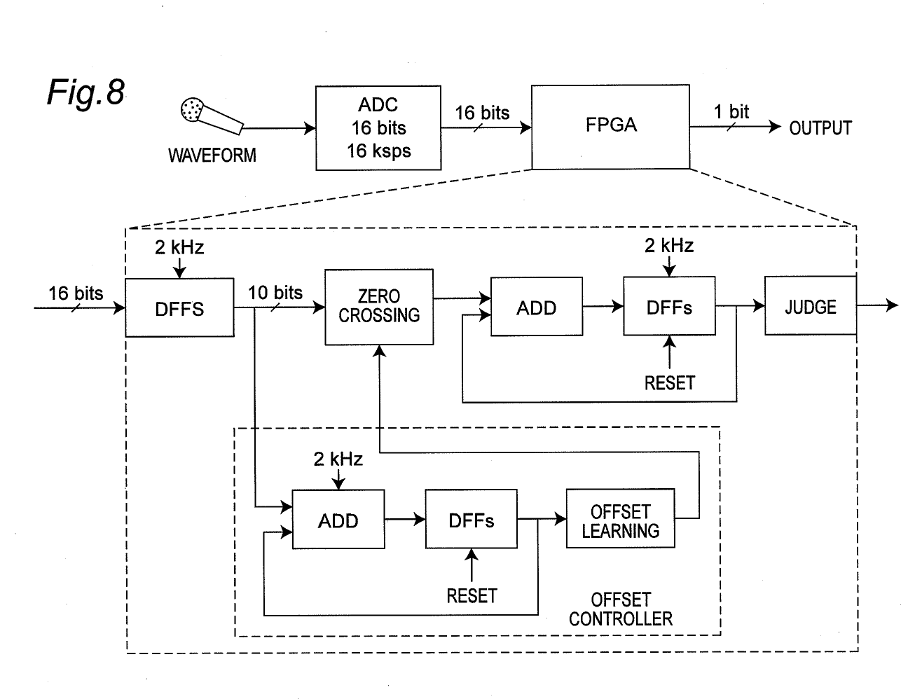

FIG. 8 shows a block diagram of the FPGA board. A supply voltage to the FPGA board is 5 V. The ADC circuit samples an analog signal with 10 bits at 16 kHz, and this sampling rate is controlled by a circuit mounted in the FPGA. Referring to FIG. 8, the data sampled by the ADC circuit is inputted directly to the FPGA chip, and the result of utterance detection is outputted from the FPGA. Calculations implemented on the FPGA are almost identical to those indicated by the flow shown in FIG. 7. The modules of zero crossing (Zero crossing), the offset control circuit (Offset learning) and the utterance judgment circuit (Judge) of FIG. 8 correspond to the respective processes of FIG. 7. That is, the zero crossing (zero crossing) shown in FIG. 8 corresponds to the process 1 and the process 2 shown in FIG. 7, the offset control circuit (offset learning) corresponds to the process 4, the process 6 and the process 7, and the utterance judgment circuit (Judge) corresponds to the process 8. The total calculations are performed in integer calculations. Regarding the state of use of the hardware resources in the implementation on the FPGA, 1015 division flip-flops and 3831 4-input LUTs (Look Up Tables) were used.

As the results of the power measurement in the FPGA, the consumption current of the whole board except the microphones became 0.42 mA, and the consumption power was 2.10 mW. Therefore, when only the fabricated utterance estimation circuit module is consistently operated, it operates for 70 hours with a battery of 150 mAh.

Next, all the blocks of the utterance estimation circuit module using the number of zero crossings were implemented by using a CMOS 0.18-μm process. The power consumption of the utterance estimation circuit module using the number of zero crossings when implemented by using the CMOS 0.18-μm process was measured, and the result was 3.49 μW under operation at 1.8 V and 100 kHz. Therefore, in the case of operation of only the utterance estimation, each sensor node can operate for 1700 days with the battery of 150 mAh.

The point of the present invention resides in that hardware dedicated for speech detection is developed and it performs the power control (turns on the switch) of the entire system as described above in contrast to the prior art that a human being turns on the power of the system and thereafter a sound is detected by the microphones and the CPU. It is examined whether or not the sound is the utterance of a human being by the speech detection, and then, the power management of the entire system is performed.

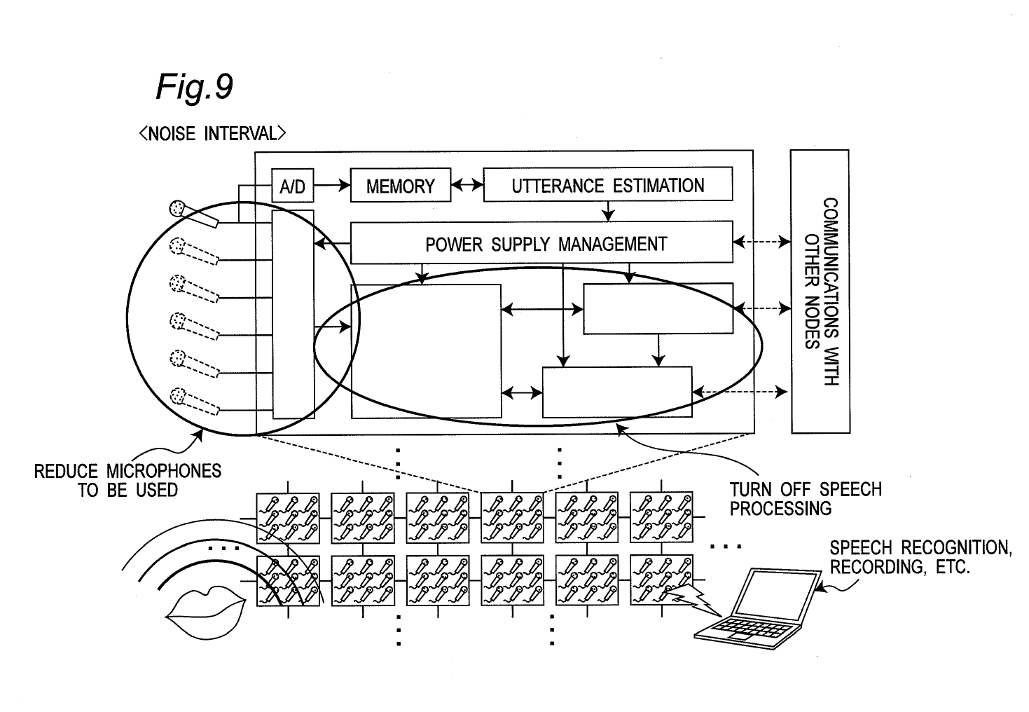

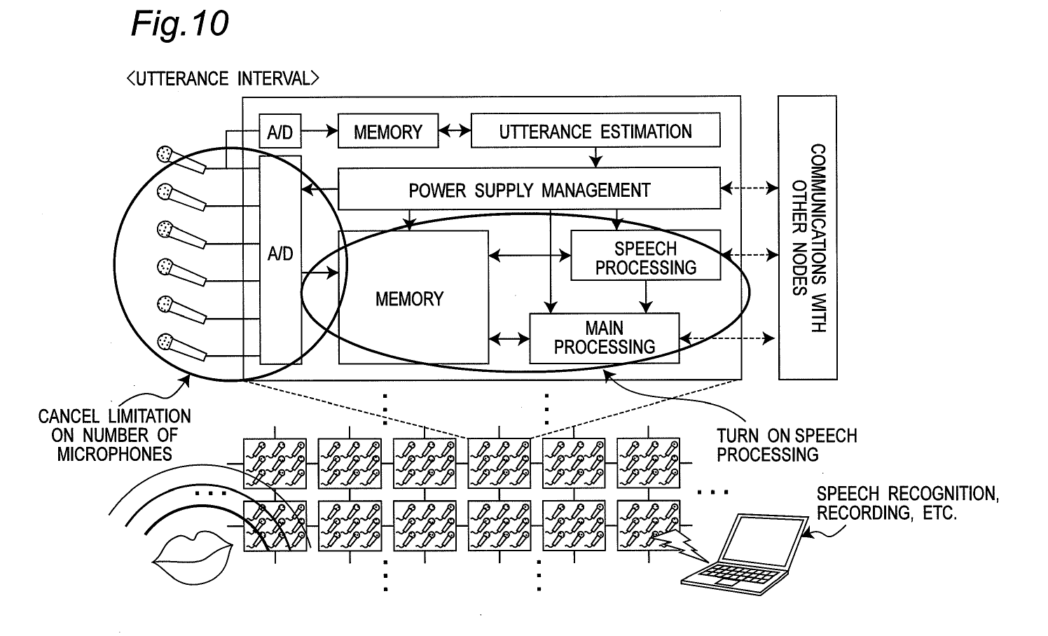

That is, in the case of a noise interval in a manner similar to that of FIG. 9, the number of microphones to be used is reduced, and the power supply of the speech processing and the main processing in the sensor node is turned off by the utterance estimation circuit and the power supply management circuit of the hardware only dedicated for the speech detection. In the case of an utterance interval in a manner similar to that of FIG. 10, the limitation on the number of microphones to be used is released, and the power supply of the speech processing and the main processing in the sensor node is turned on by the utterance estimation circuit and the power supply management circuit of the hardware dedicated for the speech detection.

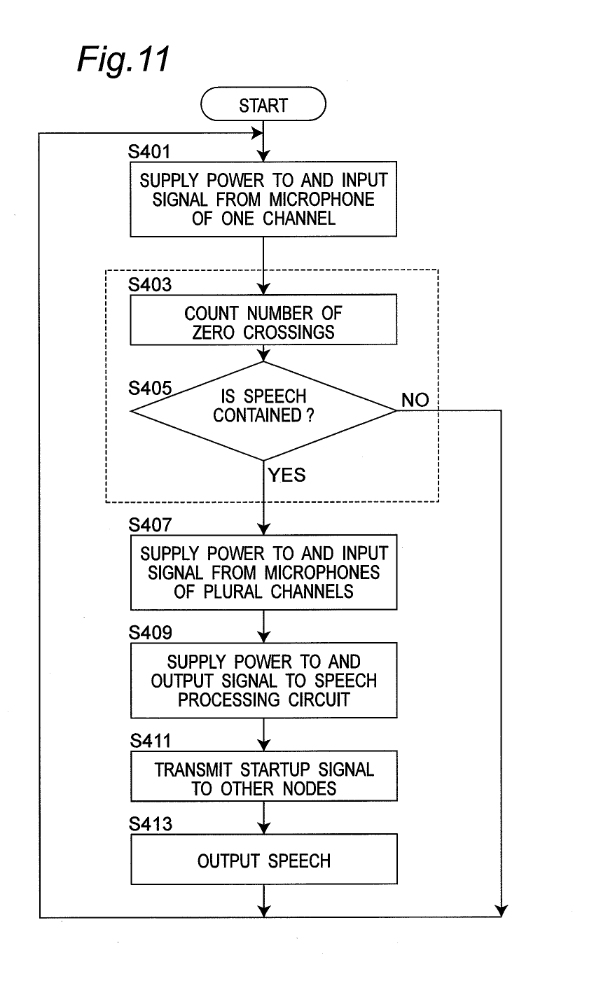

FIG. 11 shows a sensor node processing flow. First of all, the power is supplied to a microphone of one channel, and its sound signal is inputted (S401). The inputted sound is subjected to counting of the number of zero crossings by the utterance estimation circuit (S403), and it is judged whether or not a speech is contained (S405). If it is presumed that a speech is contained, the limitation on the number of microphones is released, the power is supplied to the microphones of plural channels, and sound signals are inputted (S407). Moreover, the power is supplied to the speech processing circuit and the other signal processing circuits (S409). Further, a startup signal is transmitted to the other nodes (S411). Then, a speech signal processed through the speech processing is outputted (S413).

According to the above description, during the utterance estimation, the limitation on the number of microphones is released and the power supply to the speech processing circuit and so on is turned on only for the utterance interval, and the limitation on the number of microphones is limited and the power supply to the speech processing circuit and so on is turned off for the noise interval.

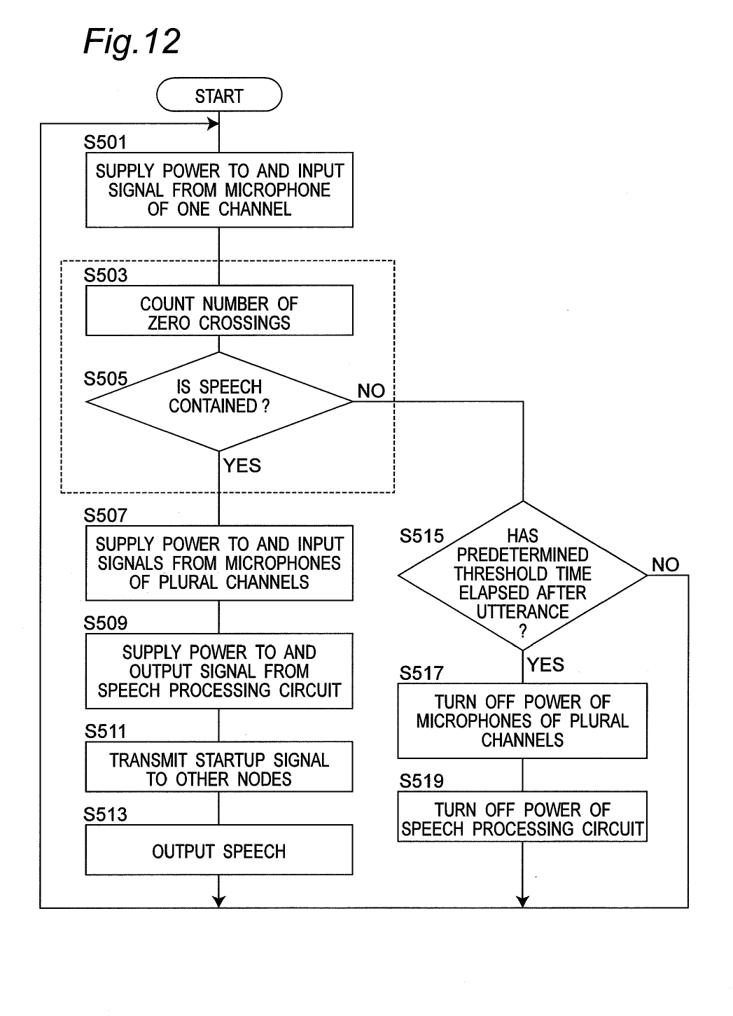

For example, when no speech is contained by the utterance estimation in a manner similar to that of the flow shown in FIG. 12 and if it is after the utterance, it is acceptable to await a lapse of a predetermined threshold time (S515), limit the number of microphones (S517) and turn off the power supply to the speech processing circuit and so on (S519).

Next, the tolerance of the utterance estimation algorithm using the number of zero crossings implemented on the hardware with respect to deterioration in the S/N ratio was experimented. The experiments were conducted under an S/N ratio environment of −20 dB to 20 dB. In the experiments, an utterly identical speech data was used under all the S/N ratio environments. The speech data has duration of 15 minutes, and is configured to include 24 kinds of ATR phonemic balance sentences. Since the frame length of the utterance estimation algorithm shown in FIG. 7 was set to 256 samples, the utterance estimation circuit module generates an output signal 7030 times for 15 minutes.

In the present experiment, the frequency of correct, the frequency of surplus, and the frequency of deficit were counted. In this case, “correct” represents the correct output of the utterance estimation circuit module, “surplus” represents the output of the utterance estimation circuit module when a non-utterance is taken as an utterance by mistake, and “deficit” represents the output of the utterance estimation circuit module when an utterance is taken as a non-utterance by mistake.

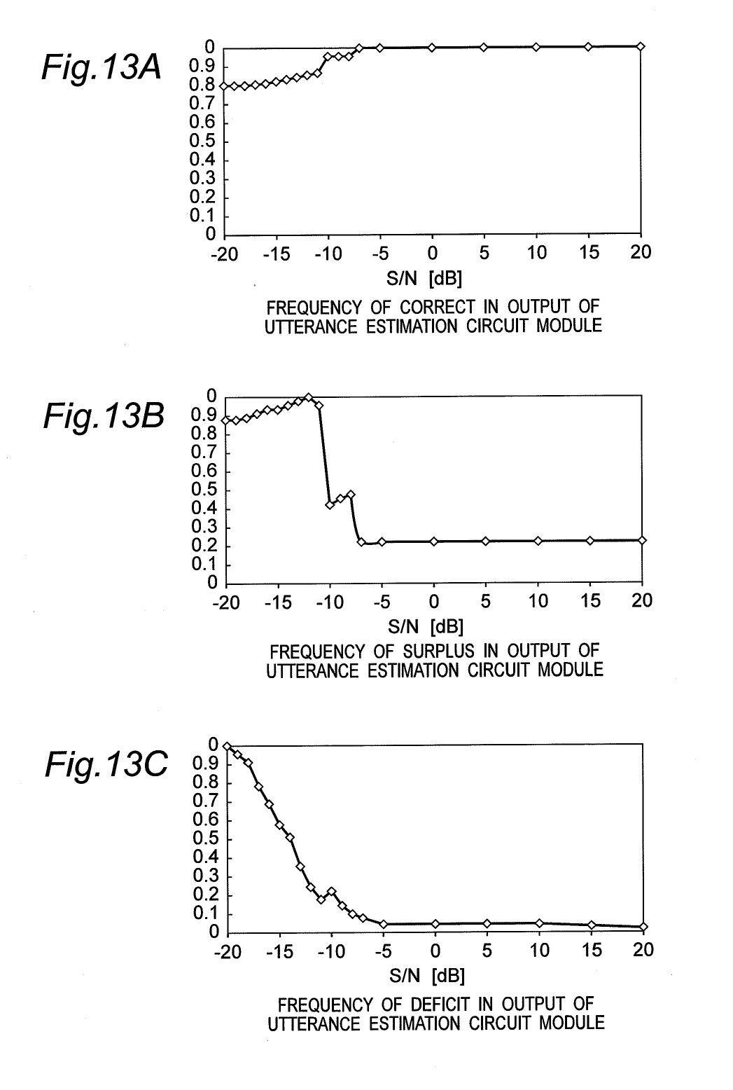

FIGS. 13A, 13B and 13C show a graph of the results of correct, surplus and deficit cases described above. In the figures, FIG. 13A shows a frequency of correct among the output signals from the utterance estimation circuit module, FIG. 13B shows a frequency of surplus among the output signals from the utterance estimation circuit module, and FIG. 13C shows a frequency of deficit among the output signals from the utterance estimation circuit module. It can be understood from FIG. 13A that an accuracy of 80% is maintained even under the S/N ratio environment of −20 dB. Moreover, it can be understood from FIGS. 13B and 13C that the power reduction efficiency and the stability of the utterance estimation circuit module are deteriorated depending on the deterioration in the S/N ratio.

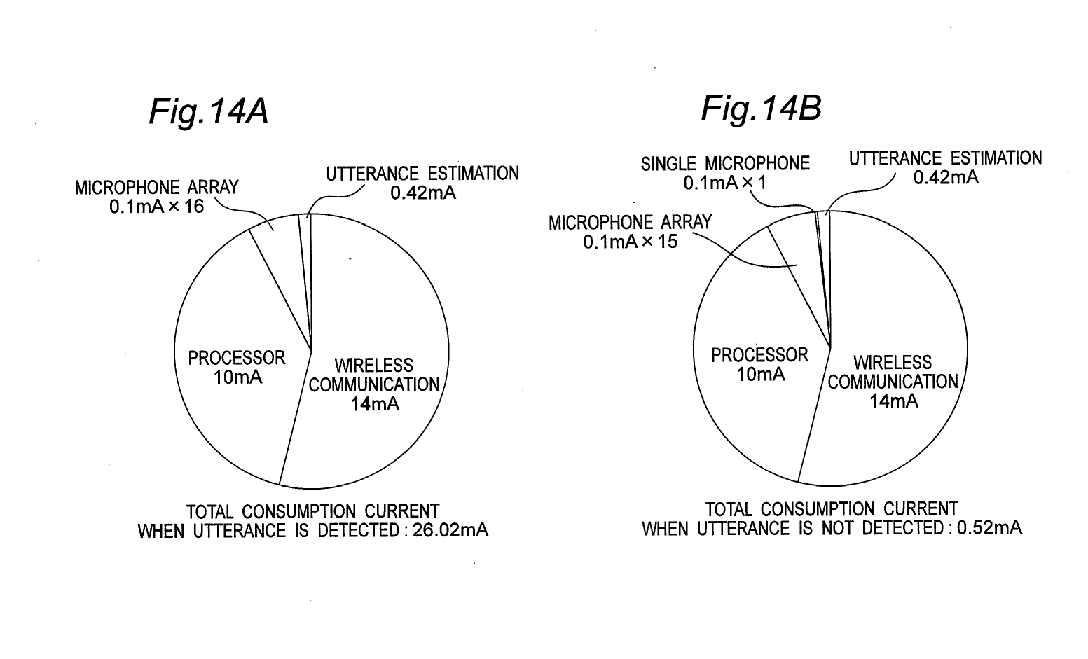

FIGS. 14A and 14B show estimates of the power of the entire sensor node of the present implemental example. The aforementioned estimate values were used for the powers of wireless communication, the processor and the microphones, and the implementation result of the FPGA is used for the power of the utterance estimation circuit module. By contrast to the consumption current of 26.02 mA in the case where an utterance is detected (FIG. 14A), and the consumption current in the case where any utterance is not detected (FIG. 14B) is 0.52 mA, this means that a power of about 2% results and a power consumption reduction of about 98% can be achieved.

The present invention is useful for speech processing systems such as microphone array systems, audio teleconference systems and home information appliances using speeches, of which the scale increase is indispensable by adoption of ubiquitous configuration in the future and speech processing systems in which individual information processing terminals operate on batteries by adoption of sensor nodes and wearable terminals.

In particular, it is effective for speech processing systems advantageously utilized in the environments where utterance intervals and noise intervals exist in mixture, such as audio teleconference systems for which speech intervals and non-speech intervals are mutually separated and human robot systems in which the presence and absence of a human being are mutually separated.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A circuit startup method utilizing utterance estimation in a speech processing system comprising a sound collecting device, the circuit startup method including the following:
a subset power supply step of supplying power to the sound collecting device and a signal processing circuit;
a sound collecting step of inputting a sound from the sound collecting device through the signal processing circuit;
an utterance estimation step of estimating whether or not a speech is contained in the inputted sound; and
a power supply step of supplying power to the speech processing circuit for an utterance interval when it is estimated that a speech is contained from an estimation result of the utterance estimation step.

2. A circuit startup method utilizing utterance estimation in a speech processing system comprising sound collecting devices, the circuit startup method including the following:
a subset power supply step of supplying power to a subset of the sound collecting devices and a signal processing circuit;
a sound collecting step of inputting a sound from the subset of the sound collecting devices through the signal processing circuit;
an utterance estimation step of estimating whether or not a speech is contained in the inputted sound; and
a power supply step of supplying power to the speech processing circuit, other sound collecting devices and other signal processing circuits for an utterance interval when it is estimated that a speech is contained from an estimation result of the utterance estimation step.

3. A circuit startup method utilizing utterance estimation in a speech processing system in which speech processing units comprising sound collecting devices are connected together in a network, the circuit startup method including the following:
a subset power supply step of supplying power to a subset of the sound collecting devices and a signal processing circuit of a self node;
a sound collecting step of inputting a sound from the subset of the sound collecting devices through the signal processing circuit;
an utterance estimation step of estimating whether or not a speech is contained in the inputted sound;
a power supply step of supplying power to the speech processing circuit, other sound collecting devices and other signal processing circuits of the self node for an utterance interval when it is estimated that a speech is contained from an estimation result of the utterance estimation step;
a startup signal transmission step of transmitting a circuit startup signal to other nodes when it is estimated that a speech is contained from the estimation result of the utterance estimation step; and
a self node power supply step of supplying power to the speech processing circuit, the sound collecting devices and the signal processing circuits of the self node when the circuit startup signal is received from other node.

4. The circuit startup method as claimed in claim 1,
wherein at least one of a bit length and a sampling frequency of signal data in the signal processing circuit is increased when it is estimated that a speech is contained from the estimation result of the utterance estimation step.

5. The circuit startup method as claimed in claim 2,
wherein at least one of a bit length and a sampling frequency of signal data in the signal processing circuit is increased when it is estimated that a speech is contained from the estimation result of the utterance estimation step.

6. The circuit startup method as claimed in claim 3,
wherein at least one of a bit length and a sampling frequency of signal data in the signal processing circuit is increased when it is estimated that a speech is contained from the estimation result of the utterance estimation step.

7. The circuit startup method as claimed in claim 1,
wherein the utterance estimation step uses a number of zero crossings.

8. The circuit startup method as claimed in claim 2,
wherein the utterance estimation step uses a number of zero crossings.

9. The circuit startup method as claimed in claim 3,
wherein the utterance estimation step uses a number of zero crossings.

10. A circuit startup program product utilizing utterance estimation in a speech processing system comprising a sound collecting device, the circuit startup program product including the following which is executed by a computer:
a subset power supply step of supplying power to the sound collecting device and a signal processing circuit;
a sound collecting step of inputting a sound from the sound collecting device through the signal processing circuit;
an utterance estimation step of estimating whether or not a speech is contained in the inputted sound; and
a power supply step of supplying power to the speech processing circuit for an utterance interval when it is estimated that a speech is contained from an estimation result of the utterance estimation step.

11. A circuit startup program product utilizing utterance estimation in a speech processing system comprising a sound collecting device, the circuit startup program product including the following which is executed by a computer:
a subset power supply step of supplying power to a subset of the sound collecting devices and a signal processing circuit;
a sound collecting step of inputting a sound from the subset of the sound collecting devices through the signal processing circuit;
an utterance estimation step of estimating whether or not a speech is contained in the inputted sound; and
a power supply step of supplying power to the speech processing circuit, other sound collecting devices and other signal processing circuits for an utterance interval when it is estimated that a speech is contained from an estimation result of the utterance estimation step.

12. A circuit startup program product utilizing utterance estimation in a speech processing system comprising a sound collecting device, the circuit startup program product including the following which is executed by a computer:
a subset power supply step of supplying power to a subset of the sound collecting devices and a signal processing circuit of a self node;
a sound collecting step of inputting a sound from the subset of the sound collecting devices through the signal processing circuit;
an utterance estimation step of estimating whether or not a speech is contained in the inputted sound;
a power supply step of supplying power to the speech processing circuit, other sound collecting devices and other signal processing circuits of the self node for an utterance interval when it is estimated that a speech is contained from an estimation result of the utterance estimation step;
a startup signal transmission step of transmitting a circuit startup signal to other nodes when it is estimated that a speech is contained from the estimation result of the utterance estimation step; and
a self node power supply step of supplying power to the speech processing circuit, the sound collecting devices and the signal processing circuits of the self node when the circuit startup signal is received from other node.

13. A circuit startup apparatus utilizing utterance estimation in a speech processing system comprising a sound collecting device, the circuit startup apparatus comprising:
a subset power supply circuit for supplying power to the sound collecting device and a signal processing circuit;
a sound collecting device for inputting a sound from the sound collecting device through the signal processing circuit;
an utterance estimation circuit for estimating whether or not a speech is contained in the inputted sound; and
a power supply circuit for supplying power to the speech processing circuit for an utterance interval when it is estimated that a speech is contained from an estimation result of the utterance estimation circuit.

14. A circuit startup apparatus utilizing utterance estimation in a speech processing system comprising sound collecting devices, the circuit startup apparatus comprising:
a subset power supply circuit for supplying power to a subset of the sound collecting devices and the signal processing circuit;
a sound collecting device for inputting a sound from the subset of the sound collecting devices through the signal processing circuit;
an utterance estimation circuit for estimating whether or not a speech is contained in the inputted sound; and
a power supply circuit for supplying power to the speech processing circuit, other sound collecting devices and other signal processing circuits for an utterance interval when it is estimated that a speech is contained from an estimation result of the utterance estimation circuit.

15. A circuit startup apparatus utilizing utterance estimation in a speech processing system in which speech processing units comprising sound collecting devices are connected together in a network, the circuit startup apparatus comprising:
a subset power supply circuit for supplying power to a subset of the sound collecting devices and the signal processing circuit of a self node;
a sound collecting device for inputting a sound from the subset of sound collecting devices through the signal processing circuit;
an utterance estimation circuit for estimating whether or not a speech is contained in the inputted sound;
a power supply circuit for supplying power to the speech processing circuit, other sound collecting devices and other signal processing circuits of the self node for an utterance interval when it is estimated that a speech is contained from an estimation result of the utterance estimation circuit;
a startup signal transmission circuit for transmitting a circuit startup signal to other nodes when it is estimated that a speech is contained from the estimation result of the utterance estimation circuit; and
a self node power supply circuit for supplying power to the speech processing circuit, the sound collecting devices and the signal processing circuits of the self node when the circuit startup signal is received from other node.

16. The circuit startup apparatus as claimed in claim 13,
wherein at least one of a bit length and a sampling frequency of signal data in the signal processing circuit is increased when it is estimated that a speech is contained from the estimation result of the utterance estimation circuit.

17. The circuit startup apparatus as claimed in claim 14,
wherein at least one of a bit length and a sampling frequency of signal data in the signal processing circuit is increased when it is estimated that a speech is contained from the estimation result of the utterance estimation circuit.

18. The circuit startup apparatus as claimed in claim 15,
wherein at least one of a bit length and a sampling frequency of signal data in the signal processing circuit is increased when it is estimated that a speech is contained from the estimation result of the utterance estimation circuit.

19. The circuit startup apparatus as claimed in claim 13,
wherein the utterance estimation circuit uses a number of zero crossings.

20. The circuit startup apparatus as claimed in claim 14,
wherein the utterance estimation circuit uses a number of zero crossings.

21. The circuit startup apparatus as claimed in claim 15,
wherein the utterance estimation circuit uses a number of zero crossings.

22. The circuit startup apparatus as claimed in claim 13,
wherein the utterance estimation circuit and the power supply circuit are implemented as dedicated hardware.

23. The circuit startup apparatus as claimed in claim 14,
wherein the utterance estimation circuit and the power supply circuit are implemented as dedicated hardware.

24. The circuit startup apparatus as claimed in claim 15,
wherein the utterance estimation circuit and the power supply circuit are implemented as dedicated hardware.
